(19) United States
(12) Patent Application Publication
(10) Pub. No.: US 2011/0266371 A1
(43) Pub. Date: Nov. 3, 2011

(54) Spray gun

(76) Inventor: James R. Fontaine, Marilla, NY (US)

(21) Appl. No.: 13/068,073

(22) Filed: May 2, 2011

Related U.S. Application Data
(60) Provisional application No. 61/343,755, filed on May 3, 2010.

(51) Int. Cl. B05B 7/02; B23P 17/00

(52) U.S. Cl. 239/528; 29/401.1

(57) ABSTRACT

A spray gun, which is convertible for use with and without an extension wand, may use the valve mechanism and nozzle attached adjacent to the handle of the gun. When spraying requires the spray to be released away from the gun handle and for spot applications of the spraying liquid, the spraying nozzle is removed and the extension wand or tube is attached to the gun handle. The valve assembly remains in place and another valve assembly and nozzle is provided at the end of the extension furthest away from the handle. A rod is attached to and extends between the valves so that they both move together from closed to open positions responsive to the trigger of the spray gun. When the valves are closed, there is no spraying liquid in the extension. The valving is dripless both with and without the extension. When the trigger is actuated for spraying, spraying liquid under pressure as from a sprayer tank passes through the first valve, the extension tube, and the second valve and exits via the spraying nozzle. The attachment to the first valve may be by a threaded end thereof screwed into a threaded blind hole of the valve of the first valve adjacent the handle. This attachment facilitates disassembly of the extension and rod assembly when only the first valve and the nozzle associated therewith is adapted to be used in spraying.

Priority is claimed to U.S. Provisional Patent Application No. 61/343,755, filed May 3, 2010, which is incorporated herein by reference.

### DESCRIPTION

The present invention relates to spray guns and particularly a spray gun which is convertible for use with and without a tube providing an extension wand, hereinafter called an extension.

Extensions are desired for use with a spray gun so as to separate the spray gun from the location where the spray is to be released, which is especially desirable when spraying toxic substances. Extensions are also desired where the spray is to be released in close proximity to the location where spraying is to be carried out as is desirable for spot applications of spraying liquid. Heretofore, spray guns, (sometimes called spray heads) have been available either with or without extensions. In some cases, the extension wand is merely attached to the end of the gun and the valving mechanism of the gun is used in order to control the flow of spraying liquid via the extension. Then spraying liquid can drip out of the extension and dripless operation is precluded. A typical spray gun with an extension with a spring biased trigger operating a rod extending to a valve at the outer end or tip of the extension is shown in various patents related to spraying heads and guns. See for example, Lichfield, U.S. Pat. No. 4,541,568, issued Sep. 17, 1985; Wahlin; U.S. Pat. No. 3,589,610, issued Jun. 29, 1971; Tracy, U.S. Pat. No. 2,214,035, issued Sep. 10, 1940; and Green et al., U.S. Pat. No. 1,837,861, issued Dec. 22, 1931. These patents show various spray guns with spring biased triggers which actuate a valve to open and close a valve seat for allowing pressurized spraying liquid to be sprayed via a nozzle, and also provide for dripless operation. It is desirable to utilize a spraying gun substantially without modification and convert it for use with an extension without otherwise effecting the operation of the spray gun while enabling dripless operation with or without the extension. It is also desired that conversion of the spray gun to operation with or without an extension be readily and quickly accomplished by personnel without a high degree of mechanical aptitude.

It is a feature of the present invention to provide an improved spray gun which is convertible for use with and without an extension without the need to modify the internals of the spray gun and to carry out the conversion entirely outside and separate from the spray gun.

Briefly described, the present invention provides a spray gun convertible for use with and without an extension, and a method of converting a spray gun or head for use with an extension when desired. The spray gun (or head) has a handle and an operating trigger which is convertible from use with a first nozzle, attached to the handle of the spray gun, to use with a second nozzle attached to the handle via an extension. The spray gun has a first valve actuatable by the trigger of the spray gun for valving spraying liquid through the first nozzle when it is attached to the handle. A second valve is disposed in the extension at the end thereof away from the handle which end is adjacent the second nozzle. When the extension is attached to the handle, the first nozzle is removed and a rod extends along within the extension and connects the first and second valves for movement together, such that both first and second valves are operable together responsive to the trigger being retracted or extended in the handle. Both valves are thus assembled with a valve seat for dripless operation. Consequently, spraying liquid passes through the first valve when the first valve is opened by the trigger and flows via the extension to the second valve and out of the second valve for spraying via the second nozzle. The liquid is normally absent from the extension and flows only when both valves are actuated. When the valves are closed, they provide for dripless shut-off. The connection between the valves may readily be accomplished by a screw threaded end of the rod which screws into the first valve. The rod itself does not impede with the flow of spraying liquid to the extension to any substantial extent, and essentially all of the pressure of the spraying fluid which may be derived from a pressurized tank attached to the spray gun is present at the second spraying nozzle at the outer end of the extension. The extension may be attached to the nozzle, that is to the orifice disc thereof by a screw clamp nut around a pipe extending from the handle. When the extension is used, the nozzle is removed and a screw clamp nut attaches the near end of the extension to the pipe. The valve mechanism, including the valve and the valve seat is assembled in operating relationship by the clamp nut. Another clamp nut connects the nozzle at the outer or the far end of the extension and assembles the second valve and its valve seat together with the nozzle in operating relationship at the far end of the extension.

The present invention further provides an attachment providing an extension for a spray gun with an outlet with a first valve. Such attachment has a tube or wand having a first end attached to the outlet and a second end with a second valve with a nozzle, and a rod extended within the tube or wand between the first valve and the second valve to enable the first and second valves to open and close simultaneously.

A method is also provided by the present invention for converting a spray gun with a trigger operated first valve for controlling flow of liquid to be sprayed to a nozzle to a second valve operated by the trigger at the end of an extension tube. Such method has the steps of replacing the nozzle with a nozzle at the end of the extension, and connecting the first valve to the second valve via a rod extending through the extension from the first valve to the second valve.

Further features and advantages of the invention will become more apparent from a reading of the following description in connection with the accompanying drawings in which:

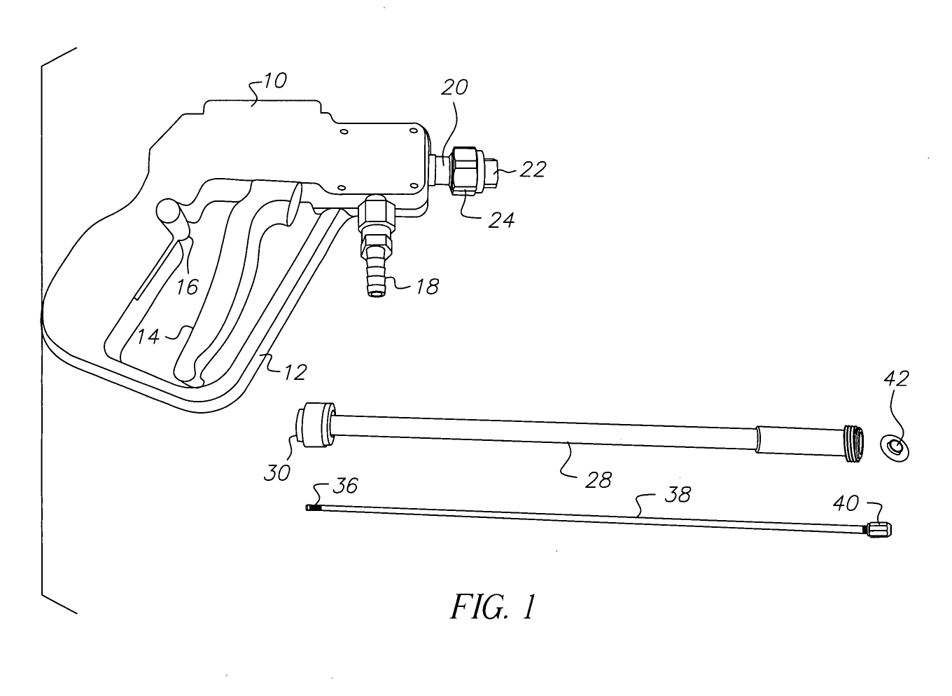

FIG. 1 is a plan view showing a spray gun with a nozzle attached to a pipe extending from the gun and also shows in exploded relationship, parts providing the extension tube and a rod for connecting a valve at the outer end of the extension tube;

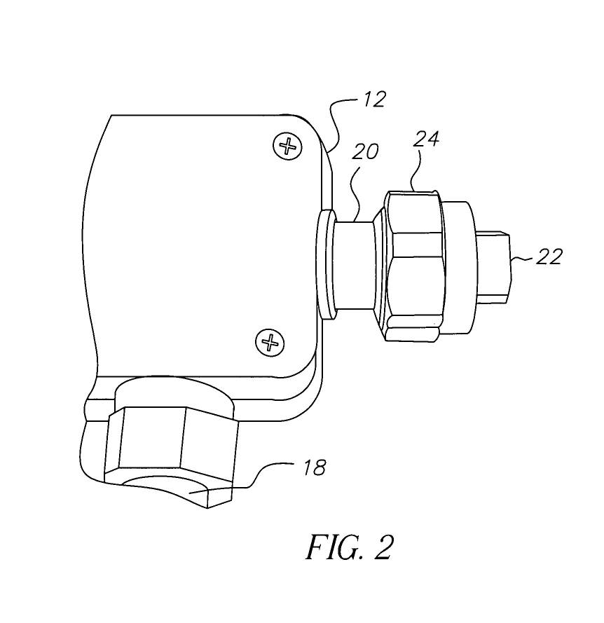

FIG. 2 is an enlarged view of the region of the gun shown in FIG. 1 which has the pipe extending from the gun handle and a nozzle attached to the pipe for use of the gun without an extension;

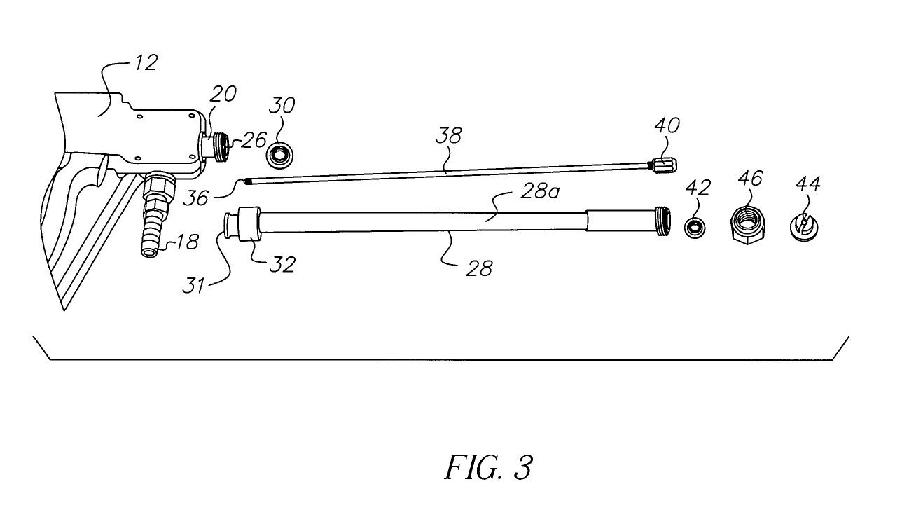

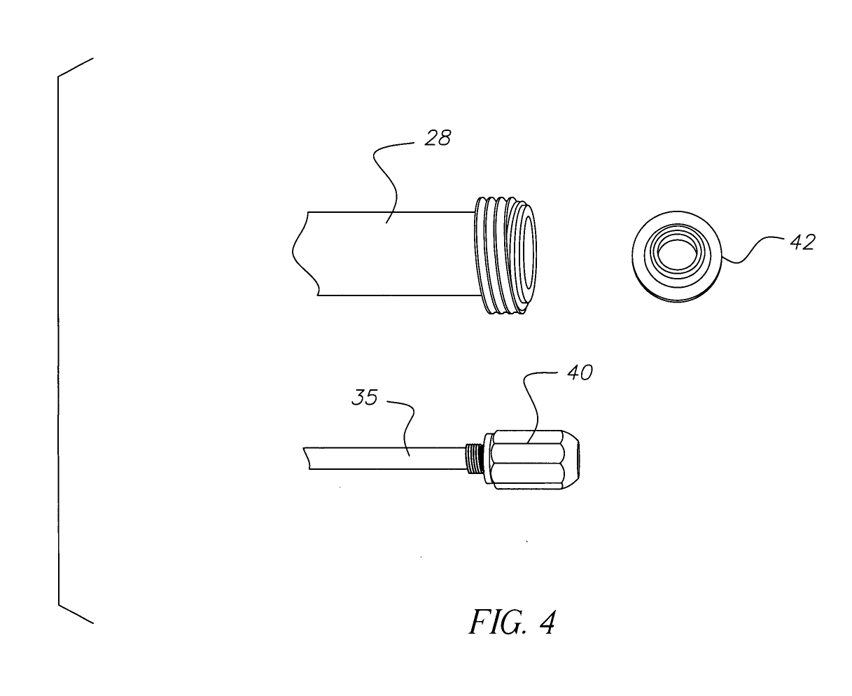

FIG. 3 is a more detailed exploded view showing the gun and parts of the mechanism providing the extension including some of the parts also shown in FIG. 1;

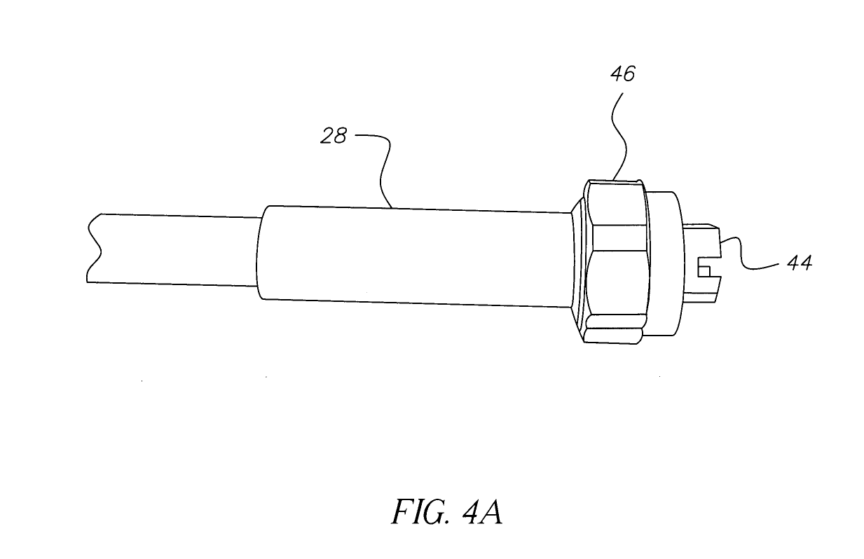

FIG. 4 is an enlarged view showing the end of the extension and the end of the valve which reciprocates within the extension and cooperates with a valve seat;

FIG. 4A shows the outer end of the extension with the nozzle assembled thereon;

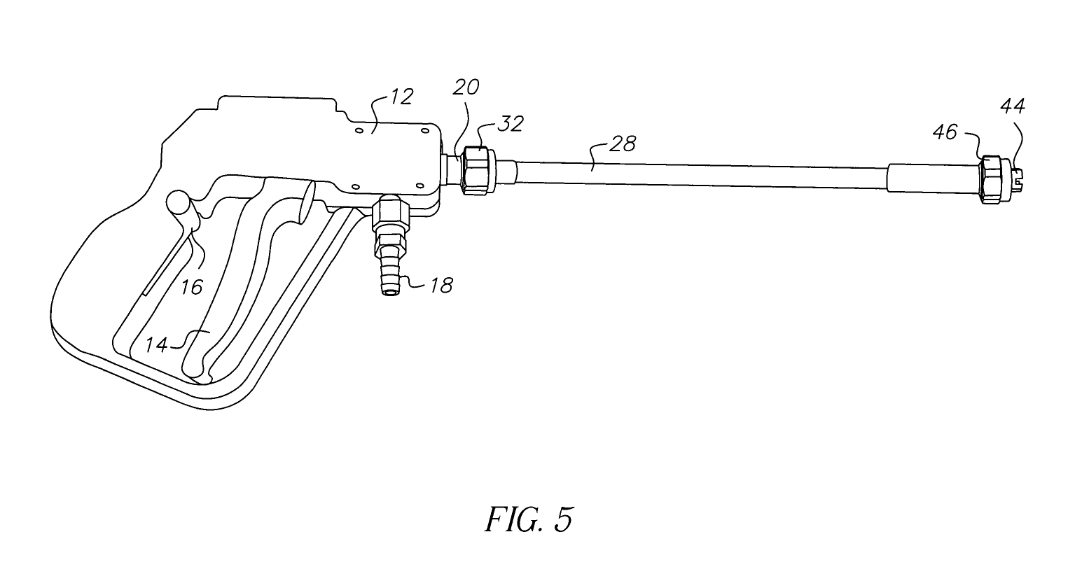

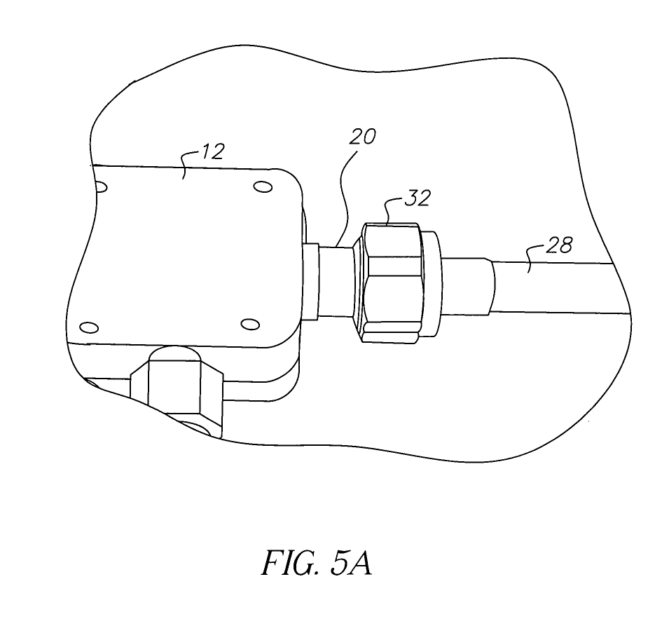

FIG. 5 is a front view of the spray gun with the extension assembled thereon;

FIG. 5A is an enlarged showing of FIG. 5 in a region adjacent to the handle of the gun;

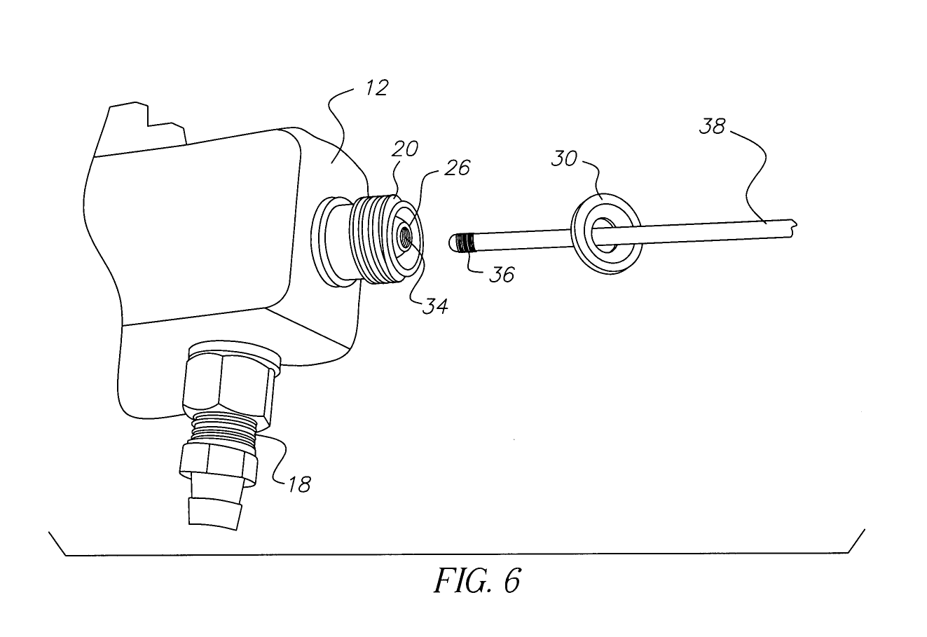

FIG. 6 is an enlarged view illustrating the pipe extending from the spray gun handle and the exposed end of the valve which is threaded to receive a threaded end of the rod, the rod extending through the valve seat before being screwed into place in the threaded hole in the valve; and

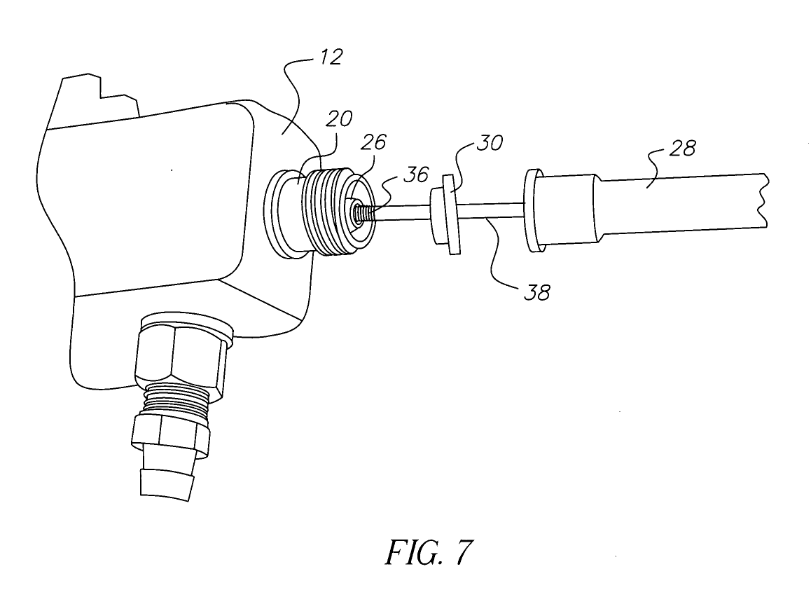

FIG. 7 is an enlarged view illustrating the assembly of the extension to the spray gun and particularly in the valve located in the pipe extending from the spray gun handle or body.

Referring to the drawings, there is shown in FIG. 1 a spray gun having a handle 12 with a lever providing a trigger 14. A pivoted stop lever 16 may be used to prevent operation of the trigger 14. The liquid to be sprayed coming from a pressurized tank via a hose is connected to a coupling 18. A pipe 20 which is threaded at the end thereof extends from the handle 12. A spray nozzle 22 is clamped to the pipe 20 by a clamp nut 24. As shown in FIG. 6, a valve 26 is disposed inside the pipe 20 and is attached to be reciprocated by the trigger lever 14 in the same manner as in prior spray guns of the types exemplified in the above-cited U.S. Patents. The valve 26 cooperates with a valve seat 30, which is assembled around the valve by the clamp nut 24. As described so far, the spray gun is adapted to spray with the nozzle and valve assembly disposed adjacent to the handle 12 of the gun. The invention enables the spray gun to be used with an extension 28 which has pipe providing a rigid tube or wand 28a. This wand has a flange end 31, and is assembled together with a valve seat 30 by means of a clamp nut 32. The valve 26 has a blind threaded hole 34 (see FIG. 6). This hole 34 receives the threaded end 36 of a coupling rod 38, which extends through the valve seat 30.

A second valve 40 which cooperates with a second valve seat 42 is disposed at the end of the rod 38 and within the far end of the extension tube 28 where it is assembled together with a nozzle or orifice disc 44 (FIGS. 3 and 4A) by a clamp nut 46 which engages the threaded far end of the extension 28.

It will therefore be apparent that the valves 26 and 40 are coupled together by the rod 38 and opened and closed simultaneously to enable the spraying fluid to be dispensed via their respective valves and out of the spraying nozzle 44 at the far end of the extensions. Dripless operation is thus provided both with and without the extension.

It is a feature of the invention that there is also a dripless shut-off both with and without the extension 28. The valves 26 and 40 with their seats 30 and 42 provide dripless valves. Dripless operation is not provided when an extension is merely attached to a single valve assembly adjacent the handle of a spray gun as in the prior art.

Accordingly, either mode of operation, that is with or without an extension, is provided for in accordance with the invention, providing a convertible spray gun. Moreover, the setup of the extension may readily be accomplished by unskilled personnel. A separate spray gun with and without extensions need not be purchased, thereby making the spraying operation efficient and more cost effective than if two spray gun types were needed.

In summary, to add extension 28 as an attachment to the sprayer gun, the nozzle 22 is removed (pulled out) and nut 24 is removed (unscrewed), and the proximal end of rod 38 is passed through valve seat 30 and threaded into valve 26 as described above, the proximal end of tube 28a is then threaded by nut 32 onto the outlet or pipe 20. The valve seat 42 is then positioned onto valve 40 at the distal end of rod 38 and held by nut 46, and the nozzle 44 is positioned into the distal end of tube 28a. To detach the extension 28 from the sprayer gun, the opposite to attachment of the extension 28 takes place, valve seat 30 is positioned onto valve 26 and retained by nut 24 onto pipe 20, and nozzle 22 positioned into pipe 20. In this manner, the spray gun is convertible for use with and without an extension without the need to modify the internals of the spray gun and to carry out the conversion readily and quickly entirely outside and separate from the spray gun by personnel without a high degree of mechanical aptitude.

The foregoing and other features and advantages of the invention will become more apparent to those skilled in the art. Accordingly, the foregoing description should be taken as illustrative, and not in a limiting sense.

What is claimed is:

1. The method of converting a spray gun with a trigger operated first valve in a handle for controlling flow of liquid to be sprayed to a nozzle connected to the handle to a second valve operated by the trigger at the end of an extension tube connected to the handle which comprises the steps of:
replacing the nozzle connected to the handle with a nozzle at the end of the extension; and
connecting the first valve to the second valve via a rod extending through the extension from said first valve to the second valve.

2. The method according to claim 1 wherein the step of connecting the first and second rods comprises the step of providing a screw-in connection into which an end of said rod is screwed.

3. The method according to claim 2 wherein said screw in connection is provided by providing a thread around said rod at said end thereof and providing a screw thread into an opening into said first valve which engages said thread on the end of said rod.

4. A spray gun having a handle and an operating trigger which is convertible for use with a first nozzle attached to the handle to a second nozzle attached to the handle via a tube providing an extension and, said spray head comprising:
a first valve actuatable by said trigger for valving spraying liquid through said first nozzle when attached to said handle;
a second valve disposed in said extension adjacent said second nozzle; and
a rod extending along said extension connecting said first and second valves for movement together so that spraying liquid passes through said first valve when opened by said trigger and flows via said extension to said second valve for spraying via said second nozzle.

5. The spray gun according to claim 4 wherein separate valve seats are engagable by said first and second valves to open and close together so that spraying liquid is present in said extension only when both valves are open for spraying, and otherwise provide for dripless operation when the valves close their respective valve seats.

6. The spray gun according to claim 5 wherein a first of said nuts selectively connecting said first nozzle on a first end of said extension to said pipe and a second of said nuts connecting said second nozzle to a second end of said extension at the opposite end thereof from said first end.

7. The spray gun according to claim 6 wherein said first and second screw clamp nuts also assemble said valve seats in cooperative relationship with said first and second valves, respectively.

8. The spray gun according to claim 4 wherein said first and second valves provide dripless valving at both upstream and downstream ends of said extension.

9. An attachment providing an extension for a spray gun having an outlet with a first valve comprising:
a tube or wand having a first end attached to said outlet and a second end with a second valve with a nozzle; and
a rod extended within said tube or wand between said first valve and said second valve to enable said first and second valves to open and close simultaneously.

10. An apparatus having a first valve operable for controlling flow of liquid to be sprayed via a first outlet comprising:
first means having a first end attachable to said first outlet and a second end with a second valve with a second outlet, in which said second valve controls flow of liquid to be sprayed via said second outlet; and
second means for connecting the first valve to a second valve to enable said first and second valves to operate simultaneously.

11. The apparatus according to claim 10 wherein said second means is extendable within said first means between said first valve and said second valve.

12. The apparatus according to claim 10 wherein said first means replaces a nozzle at said first outlet through which liquid is sprayable when said first means is not attached to said first outlet.

13. The apparatus according to claim 10 wherein said second outlet has a nozzle through which liquid is sprayable via said first means when attached to said first outlet.
